(19) United States
(12) Patent Application Publication
(10) Pub. No.: US 2018/0146804 A1
(43) Pub. Date: May 31, 2018

(54) Container Clipping and Organizing Systems

(71) Applicants: Nathan Travisono, San Antonio, TX (US); Matthew Travisono, Richmond, RI (US)

(72) Inventors: Nathan Travisono, San Antonio, TX (US); Matthew Travisono, Richmond, RI (US)

(21) Appl. No.: 15/823,976

(22) Filed: Nov. 28, 2017

Related U.S. Application Data
(60) Provisional application No. 62/426,704, filed on Nov. 28, 2016.

(51) Int. Cl. A47F 7/28; F16B 1/00; F16B 2/22; F16B 47/00

(52) U.S. Cl. CPC A47F 7/285; F16B 1/00; F16B 2001/0035; F16B 47/00; F16B 2/22

(57) ABSTRACT

Container docking systems are provided for arranging, organizing, and displaying small to medium sized containers holding different but related types of products. The systems provide clips and clip support structures that facilitate identification and access to products contained in cylindrical containers of consistent size and geometry. A first embodiment provides a modular carousel tower with rotating clip wheels that position a number of clips to receive and retain the container. The clips incorporate arm and tab elements that facilitate insertion and removal of the container. A second embodiment removes the clip structure from a specific support structure and positions a magnet or other reusable adhesive on a clip base, allowing the user to move the clip and bottle to any position on an existing or provided attractive surface. A hybrid embodiment combines the magnetic or adhesive clip base structure with a carousel to provide attachment surfaces arranged on a tower.

### CROSS REFERENCES TO RELATED APPLICATIONS

This application claims the benefit under Title 35 United States Code § 119(e) of U.S. Provisional Patent Application Ser. No. 62/426,704; Filed: Nov. 28, 2016; the full disclosure of which is incorporated herein by reference.

### BACKGROUND OF THE INVENTION

### 1. Field of the Invention

The present invention relates generally to structures and systems for organizing and displaying products or product containers. The present invention relates more specifically to structures and systems for receiving, retaining, and organizing small cylindrical bottles, especially bottles containing variations of a similar type of product.

### 2. Description of the Related Art

Some types of products that consumers purchase and use are specific variations of a general type of product or product container. These general categories of products or product containers may include many different specific products that might be used by the consumer in different situations or for different purposes. Such general types of products include, without limitation: paints of different colors; spices of different kinds; cosmetics of different types, shades and colors; and essential oils of different varieties. Where such “lines of products” exist it is common to package the products in the same size and shape containers that have differing labels to identify the specific product contained. While consistent product packaging facilitates the users' access to the products, it still often requires the user to individually pick up each container to view the label and find the specific product they need at that time.

Some efforts have been made in the past to organize such products to further facilitate their use. Most such efforts, however, lack versatility and restrict the user to a single unique structure that may or may not provide the type of organization that the user wants. In many instances, such organizing structures are sold as part of a kit that includes a specific number of the products being organized with no provision for expansion or alteration of the organizing system. It would be desirable to have a product organizing system that addresses these problems.

### SUMMARY OF THE INVENTION

The present invention provides container docking and organizing systems that address many of the problems associated with arranging, organizing, and displaying a number of small to medium sized containers of similarly packaged products. Where such products are contained within consistently sized and shaped cylindrical bottles or the like, the present invention provides a system of unique clips and clip support structures. A first embodiment of the system provides a modular carousel tower with rotating clip wheels that each position a number of specifically structured clips to receive and retain the container bottles. The individual clip structure of the present invention incorporates arm and tab elements that facilitate the users' insertion and removal of the container bottle into or from the clip. A second embodiment takes the clip structure defined, off of the carousel tower and positions a strong magnet or other reusable adhesive surface, on a clip base, thereby allowing the user to move the clip and bottle to any position on existing or provided ferromagnetic or other adhesive surfaces. A third embodiment provides a smaller number of clips in a linear row integrated onto a vertically mountable plate. A further hybrid embodiment combines the magnetic base structure of the second embodiment with the carousel tower structure of the first embodiment, to provide an array of ferromagnetic or other adhesive surfaces arranged on a display tower to allow the user to customize the number and arrangement of bottles and clips on display for use.

### BRIEF DESCRIPTION OF THE DRAWINGS

FIG. 1 is a perspective view of a first preferred embodiment of a carousel tower assembly of the system of the present invention shown with a number of essential oil bottles positioned in clips on the carousel tower.

FIG. 2 is a perspective view of the first preferred embodiment of the carousel tower assembly of the system of the present invention shown without the essential oil bottles in position.

FIGS. 3A & 3B are detailed perspective views of the tower base component of the first preferred embodiment of the carousel tower assembly of the system of the present invention.

FIGS. 4A & 4B are detailed perspective views of one of the tower trunk cylinders of the carousel tower assembly of the system of the present invention.

FIGS. 5A & 5B are a detailed plan view (FIG. 5A) and a detailed perspective view (FIG. 5B) of one of the carousel clip wheels of the carousel tower assembly of the system of the present invention.

FIGS. 5C & 5D are a detailed perspective view (FIG. 5C) and a detailed plan view (FIG. 5D) of the individual bottle clip components of the carousel tower assembly of the system of the present invention.

FIGS. 6A & 6B are detailed perspective views of the tower top component of the carousel tower assembly of the system of the present invention.

FIGS. 7A & 7B are detailed perspective views of an alternate preferred embodiment of an individual bottle clip component of the system of the present invention.

FIGS. 7C-7E are a detailed bottom plan view (FIG. 7C), top plan view (FIG. 7D), and side elevational view (FIG. 7E) of the alternate preferred embodiment of the individual bottle clip component shown in FIGS. 7A & 7B.

FIG. 7F is a detailed side view of the individual bottle clip shown in FIGS. 7A & 7B positioned on a ferromagnetic surface through the adherence of the magnet on the clip.

FIG. 7G is a detailed perspective view of a further alternate preferred embodiment of an individual bottle clip component of the system of the present invention.

FIG. 7H is a detailed perspective view of the further alternate preferred embodiment of an individual bottle clip component of the type shown in FIG. 7G, implemented on the carousel clip wheel of the embodiment shown in FIG. 5B.

FIG. 8 is a perspective view of a docking strip embodiment of the system of the present invention shown with a number of magnetic (or other adhesive) based bottle clips, some of which retain essential oil bottles.

FIGS. 9A & 9B are detailed perspective views of an individual essential oil bottle positioned on and secured by an individual magnetic (or other adhesive) based bottle clip. FIG. 9A provides a front perspective view, and FIG. 9B provides a rear perspective view.

FIG. 10 is a perspective of an alternate preferred embodiment of a docking tower assembly of the system of the present invention shown with a number of magnetic (or other adhesive) based bottle clips, most of which retain essential oil bottles in position on the docking tower assembly.

FIG. 11 is an exploded perspective view of the docking tower assembly shown in FIG. 10 (without the bottle clips and essential oil bottles) with one level of the docking module already fixed to the base of the tower, and with second and third docking modules positioned for placement on top of the base docking module.

FIG. 12 is a perspective view of an alternate preferred embodiment of a docking strip of the present invention.

### DETAILED DESCRIPTION OF THE PREFERRED EMBODIMENTS

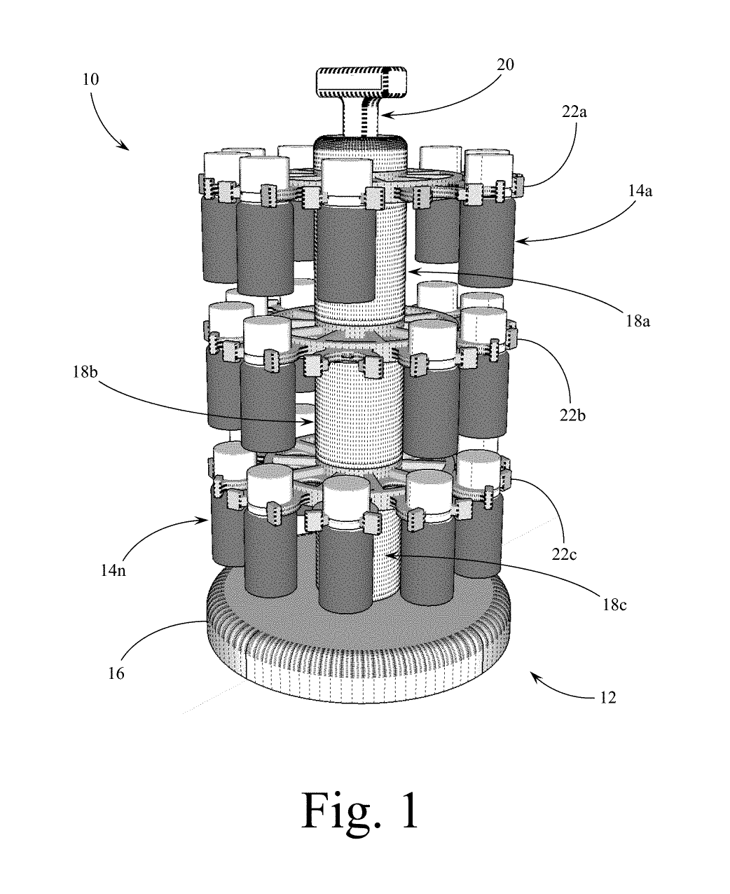

Reference is made first to FIG. 1 for a detailed description of a first preferred embodiment of the container docking and organizing system of the present invention. Although the following description anticipates its best use in connection with generally small cylindrical bottles of the type generally used to contain essential oils and the like, those skilled in the art will recognize that scaling the bottle size up or down, or even altering its geometry to a limited extent, does not necessarily alter the usefulness of the structures described in the present system. In other words, although this description focuses on the use of essential oil bottles and their organization and display, other types of cylindrical bottles and containers could be used in conjunction with the same or similar docking and organizing systems.

FIG. 1 shows bottle carousel system 10 with a large number of essential oil bottles 14a-14n positioned thereon. Bottle carousel system 10 is made up primarily of carousel tower 12 which itself is constructed of carousel tower base 16, tower trunk cylinders 18a-18c, and tower top 20. Positioned in a spaced manner on this tower structure are carousel clip wheels 22a-22c. Although three tower levels are shown and described in FIG. 1, those skilled in the art will recognize that fewer or more tower levels may be incorporated into the structure of carousel tower 12. As described in more detail below, the tower trunk cylinders 18a-18c may be separated and/or removed to have additional tower trunk cylinders added below tower top 20.

As shown in FIG. 1, essential oil bottles 14a-14n are held in an organized manner within clips positioned radially around each of carousel clip wheels 22a-22c. Each of the carousel clip wheels 22a-22c is preferably rotatable about trunk cylinders 18a-18c as described in more detail below. In this manner, the user may arrange and organize a large number of essential oil bottles 14a-14n on the various levels of carousel tower 12 and access such bottles by rotating one of the carousel clip wheels until the essential oil bottle of interest is in view.

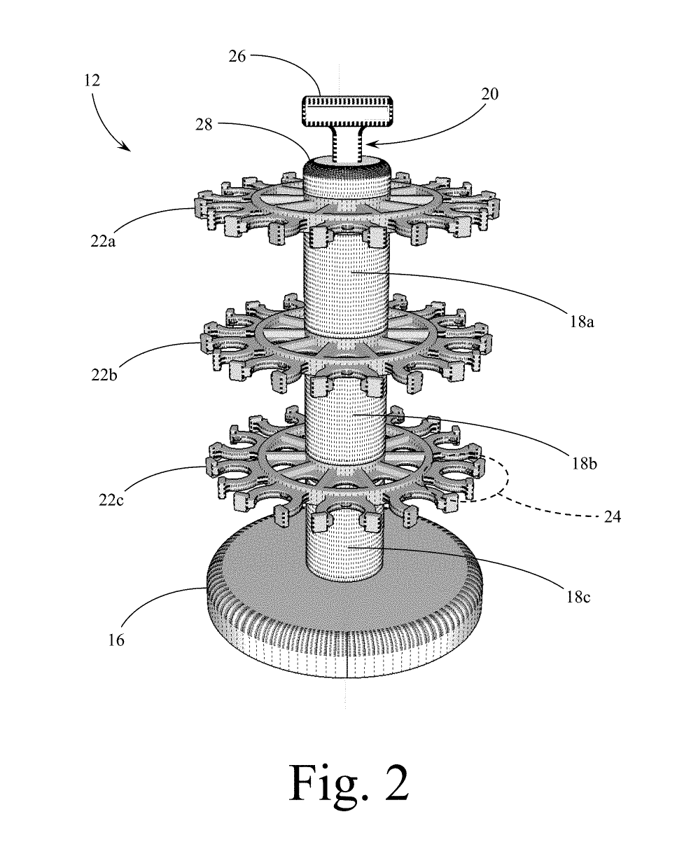

FIG. 2 shows carousel tower 12 as shown in FIG. 1 but without the retention of any essential oil bottles. In FIG. 2 the various components of carousel tower 12 are better shown and described. Once again, carousel tower 12 is structured with carousel tower base 16 onto which is secured tower trunk cylinder 18c. Positioned between tower trunk cylinders 18c & 18b is carousel clip wheel 22c. Again, the manner of connecting the tower trunk cylinders together is described in more detail below. Positioned above tower trunk cylinder 18b is carousel clip wheel 22b which is held in place by securing tower trunk cylinder 18a on top thereof. Finally, carousel clip wheel 22a is held between tower trunk cylinder 18a and top trunk cap 28. Incorporated into top trunk cap 28, and forming part of tower top 20, is top handle grip 26.

Each carousel clip wheel in the embodiment shown in FIG. 2 incorporates a number of individual bottle clips 24. The number of clips is determined in part by the size of the bottles to be incorporated onto the organizing tower, and by the number of containers the typical user might require (based on the type of products involved). In the version shown in FIG. 2 there are ten individual bottle clips 24 at each carousel clip wheel level.

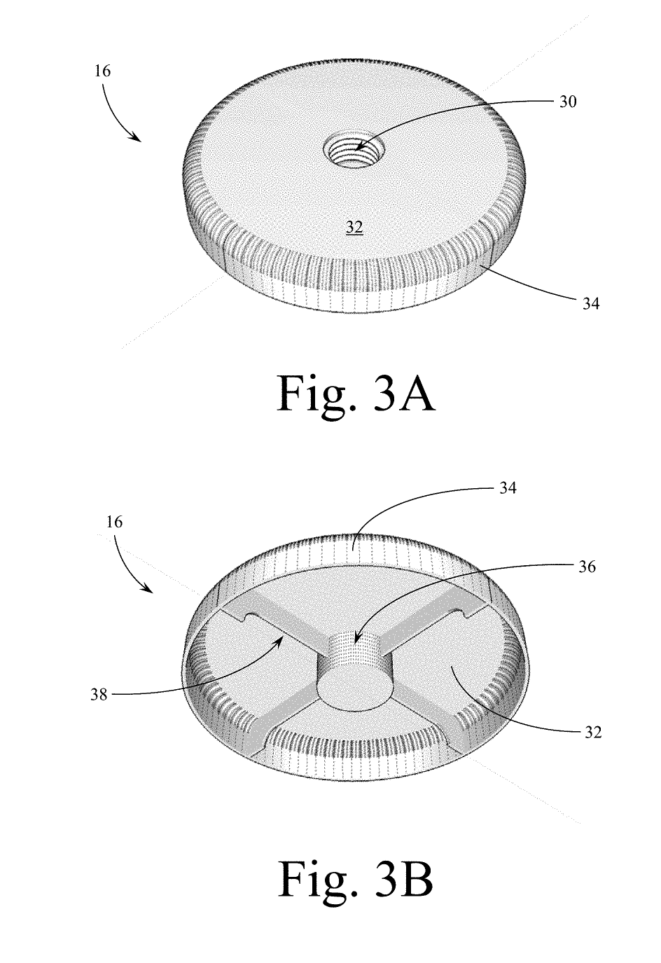

Carousel tower base 16 is shown in greater detail in FIGS. 3A & 3B. Carousel tower base 16 is made up of base plate 32 with perimeter base wall 34 forming an elevated platform support for the tower. Threaded center aperture 30 is positioned in the middle of base plate 32 in order to receive and secure the first of the tower trunk cylinders as described above. The underside of carousel tower base 16 is seen in FIG. 3B where base wall 34 is shown to surround and connect with base support ribs 38. Base support ribs 38 each extend to base trunk support 36 which forms the walled cylindrical structure for threaded center aperture 30 seen in FIG. 3A. The underside of base plate 32 is seen in FIG. 3B to be supported by the base support ribs 38.

The carousel tower base 16 shown in FIGS. 3A & 3B is but one possible embodiment for the tower support. It is not essential that the tower base be circular, although the structure of the base shown in FIGS. 3A & 3B does provide the smallest footprint for tabletop or countertop placement. Alternate embodiments for carousel tower base 16 may include rotational mechanisms having centralized bearings that would allow the entire tower to be rotated (instead of or in addition to the rotating clip wheels). In the preferred embodiment shown in the attached drawings, the individual carousel clip wheels do rotate about the center axis of the carousel tower, thereby eliminating the need to have a rotating base. It should be recognized, however, that the preferred rotation of the bottles on the tower may be accomplished either by the individually rotating carousel clip wheels or by providing a carousel tower base that itself rotates on the tabletop or countertop surface.

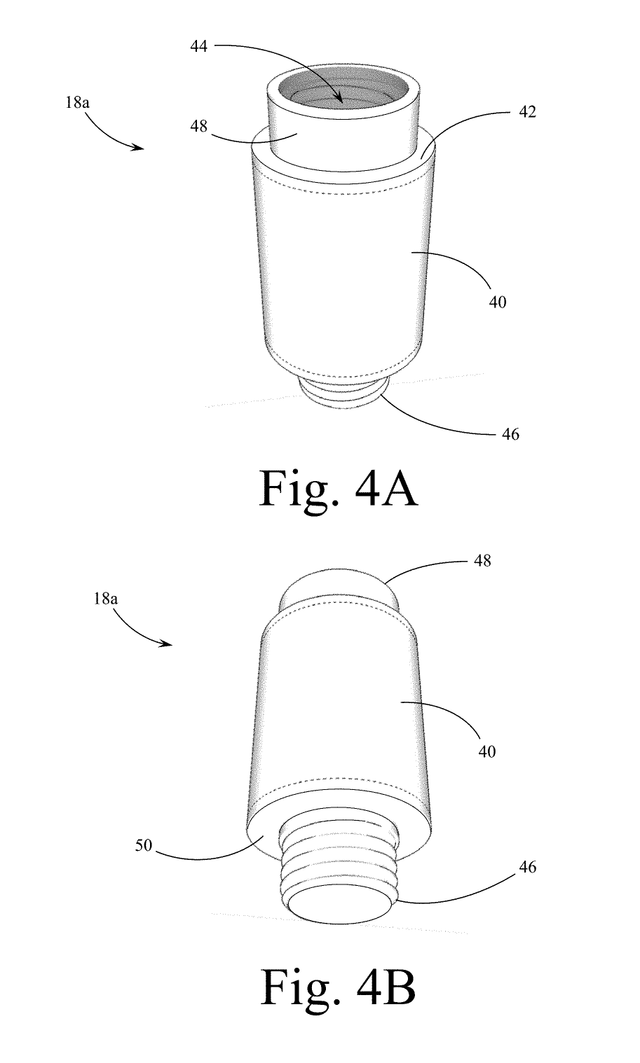

Reference is next made to FIGS. 4A & 4B which provide detailed views of the tower trunk cylinders that make up the center post of carousel tower 12, as shown in FIG. 1. Tower trunk cylinder 18a (as an example) shown in FIG. 4A is constructed with trunk cylindrical body 40 forming trunk cylindrical top shelf 42 at the upper end of the cylinder below wheel post 48, and trunk threaded connector post 46 at the lower end of the cylinder. Wheel post 48 has a diameter incrementally smaller than trunk cylindrical body 40 and thereby provides the nominal width of trunk cylinder top shelf 42 on which a carousel clip wheel is supported and may rotate. The interior of wheel post 48 provides trunk threaded connector cup 44 which is sized and threaded to receive and connect with a corresponding trunk threaded connector post 46 from a second tower trunk cylinder. Alternately, trunk threaded connector cup 44 may accept and retain threaded top trunk cap 28 as part of tower top 20 as shown in FIGS. 1 & 2. Likewise, trunk threaded connector post 46 may insert into and be retained by threaded center aperture 30 of carousel tower base 16 as shown in FIG. 3A.

FIG. 4B shows the lower portion of tower trunk cylinder 18a detailing trunk threaded connector post 46 and trunk cylinder bottom shelf 50. As trunk cylinder top shelf 42 provides support for and allows the rotation of a carousel clip wheel around wheel post 48 so does trunk cylinder bottom shelf 50 secure the top face of a carousel clip wheel in a manner that retains it in a horizontal orientation without preventing it from rotating about the center axis of the carousel tower. Securely positioning each carousel clip wheel in this manner without preventing its rotation is a matter of sizing and structuring trunk threaded connector post 46 and the depth to which it may be threaded into trunk threaded connector cup 44 on a corresponding tower trunk cylinder. As indicated above, threaded connector post 46 is also sized to be securely positioned within threaded center aperture 30 of carousel tower base 16 shown in FIG. 3A.

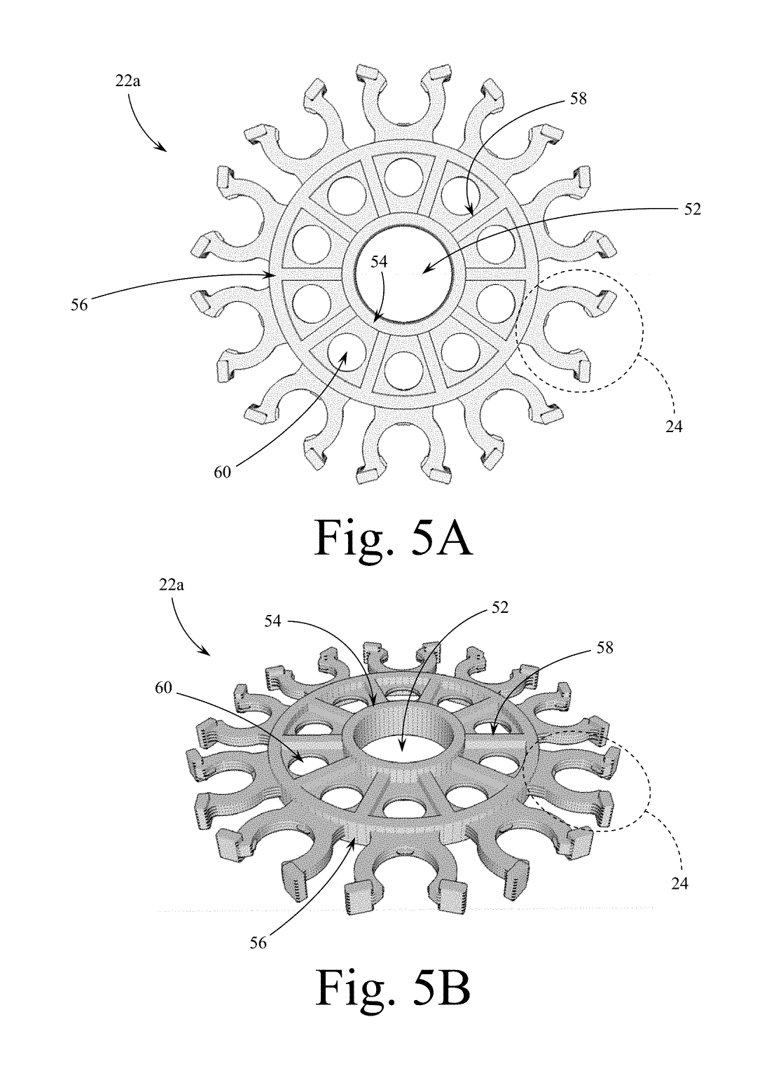

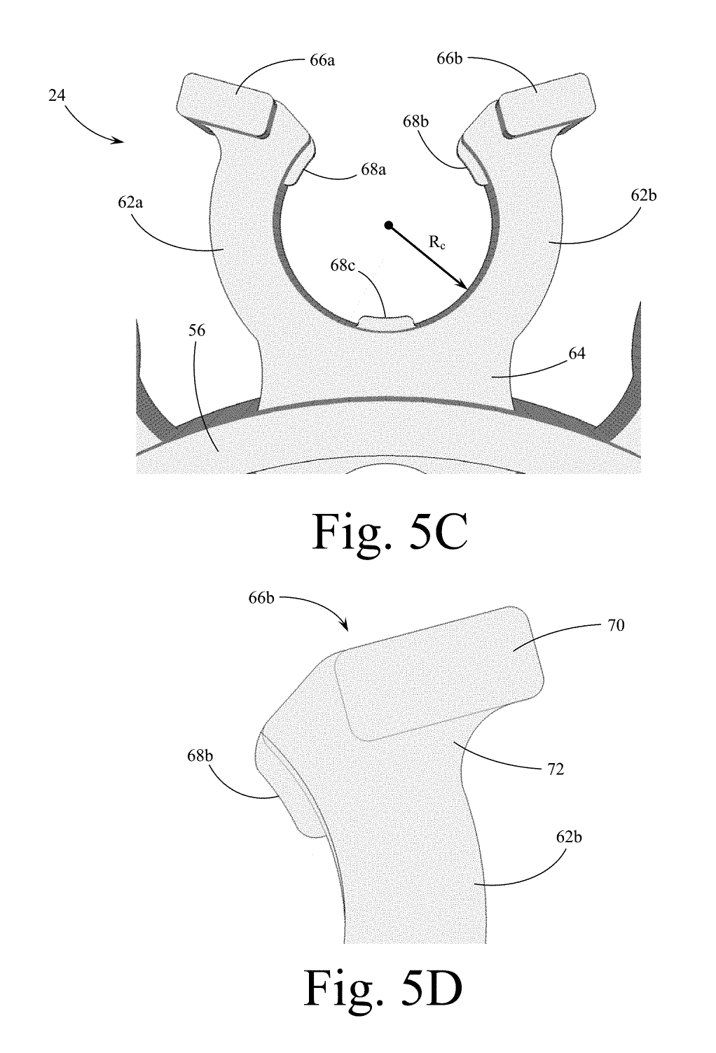

Reference is next made to FIGS. 5A & 5B for a detailed description of a preferred embodiment of the carousel clip wheel of the present invention. Each carousel clip wheel 22a (as the example shown in FIGS. 5A & 5B) is preferably a unitary structure, typically of a polymer plastic molded material that provides a radial array of individual bottle clips 24. Once again, in the preferred embodiment shown and described herein, carousel clip wheel 22a is constructed with ten individual bottle clips 24. The important structures of each bottle clip 24, as well as alternate embodiments of the same, are described in greater detail below.

Carousel clip wheel 22a is shown to be constructed with a center mounting rim 54 which forms the wall of center mounting aperture 52 which, as seen in FIG. 2, is the structure that receives and is retained by a pair of tower trunk cylinders as shown in FIGS. 4A & 4B. Extending out from center mounting rim 54 are wheel spoke ribs 58. The number of wheel spoke ribs may vary although certain structures described below associated with carousel clip wheel 22a generally result in there being one wheel spoke rib for each individual bottle clip 24. If present on the carousel clip wheels, wheel spoke ribs 58 extend between center mounting rim 54 and perimeter clip rim 56. Each wheel spoke rib 58 is directed radially outward in a position generally between two adjoining individual bottle clips 24. The area between two adjoining wheel ribs 58, and between center mounting rim 54 and perimeter clip rim 56, is a flat portion of material primarily serving to define finger grip aperture 60. Once again, structuring the carousel clip wheels with spokes is not essential to the functionality of the present invention. The area between center mounting rim 54 and perimeter clip rim 56 could simply be a flat disc area interrupted only by finger grip apertures 60.

The function of finger grip aperture 60 is to facilitate the user's placement and removal of an individual bottle from the corresponding bottle clip positioned proximate to the finger grip aperture. Because some modest amount of force is required to insert the bottle into the individual bottle clip (as described in more detail below) it is preferable that the user be able to provide a counterforce, so as to effectively squeeze the bottle into the clip by positioning one finger in finger grip aperture 60 and pressing (with the thumb, for example) the bottle into the corresponding bottle clip 24.

While FIG. 5A provides a top plan view showing each of the ten sets of functional elements associated with carousel clip wheel 22a, FIG. 5B is a perspective view which provides a better description of the depth or thickness of each of the components and the manner in which the user might view the clip wheel as bottles are inserted into place or removed from the individual bottle clips 24. Once again, those skilled in the art will recognize that a fewer or a greater number of individual bottle clips 24 may be incorporated onto each carousel clip wheel. The number of ten clips per wheel shown in the preferred embodiment lends itself to the size and structure of essential oil bottles and the appropriate preferred size of the overall carousel tower. It should be recognized that on any given carousel tower, carousel clip wheels of different sizes having different numbers of individual bottle clips are possible. As long as the structure of the center mounting rim is the same, the structure of the carousel clip wheel may vary according to the user's needs. In other words, a kit that provides the various components in the bottle carousel system of the present invention may provide for larger or smaller numbers of bottle clips on each carousel clip wheel, and may even provide for different types of clips where variations in bottle geometry are anticipated.

Despite the above described possible variations in the geometry of the bottle containers to be held within the structure of the present invention, certain preferred clip geometries and structures are characterized in the present invention that lend themselves to the typical geometry and structure of an essential oil bottle container. Therefore, while essential oil bottles are referenced throughout this disclosure, those skilled in the art will recognize the wide variety of small bottles and containers that could be used with the structures of the present invention. FIG. 5C provides a detailed view of a preferred individual bottle clip 24 of the type associated with the carousel clip wheels of the present invention. Individual bottle clip 24 is shown attached to (molded as part of) perimeter clip rim 56 at clip base 64. Extending out from perimeter clip rim 56 the C-shaped individual bottle clip 24 is made up of clip arm 62a & 62b. Each clip arm terminates with clip arm handles 66a & 66b respectively as shown. The inside circular area defined by clip arms 62a & 62b has a radius R_{c} that is primarily defined by the typical bottle geometry and size that the system is designed to be used with. In the preferred embodiment described herein (i.e. used with essential oil bottles) R_{c} may optimally be 10.9 mm in radius. This is incrementally smaller than the cylindrical radius of a typical essential oil bottle in order for the bottle to expand the clip slightly and thereby allow the resiliency of the clip arms to grip the bottle in place. Clip arms 62a & 62b preferably provide a semi-circle with 250-310 degrees of arc, providing an opening of 50-110 degrees of arc.

In addition to a specified clip radius (R_{c}) the preferred embodiment of the present invention incorporates a number of retention tabs, either centered or flush on the inner surface wall formed by clip arms 62a & 62b. Specifically, base retention tabs 68c is positioned opposite the opening between clip arms 62a & 62b while arm clip retention tabs 68a & 68b are positioned on either side of the clip opening. These retention tabs 68a-68c are designed to engage the area on a typical bottle between the bottle cap and the container portion. In this manner, the bottle is securely positioned within the clip and, even though the cylindrical bottle may have a diameter about the same as the cylindrical bottle cap, it may still be vertically retained within the clip by way of the retention tabs 68a-68c which prevent the bottle from sliding up or down within the clip when properly engaging the neck band area of the bottle.

FIG. 5D shows in greater detail the structure of the end of each of clip arms 62a & 62b. Clip arm 62b is shown as an example in FIG. 5D although clip arm 62a is the mirror image thereof. Clip arm 62b terminates in clip arm handle 66b which is made up of clip arm end support 72 and finger grip extension 70. Arm clip retention tab 68b is shown where it is positioned immediately inside the opening of the clip arm 62b. Seen most clearly in FIG. 5B, for example, these detailed structures of the individual clip arms are provided to facilitate the user's placement and removal of an individual bottle into the bottle clip. The opening formed between clip arms 62a & 62b is, of course, smaller than the diameter of the bottle, even at the neck band portion of the bottle. In order to push through this opening, and thereby be positioned securely within and between the clip arms, the bottle must force the clip arms outward. The material from which the clip arms (and the balance of the carousel clip wheel) are made is resilient enough to permit this expansion and return contraction of the individual bottle clip opening.

Finger grip extension 70 shown in FIG. 5D provides the user with a surface to exert a force onto with their fingers to expand the clip opening, especially when a bottle is being removed. Once again, the insertion into the clip is facilitated primarily by the user engaging a finger in the finger grip aperture 60 associated with the bottle clip (see FIGS. 5A & 5B) and pushing on the bottle, which itself forces the clip arms apart until the bottle is fully inserted through the clip opening. Removal of the bottle, in contrast, is facilitated by the user pressing against one or both of the finger grip extensions 70 positioned at the end of each of the clip arms so as to widen the clip opening and allow for the easy removal of the bottle. Alternate embodiments for the individual clip structure of the present invention are described in more detail below.

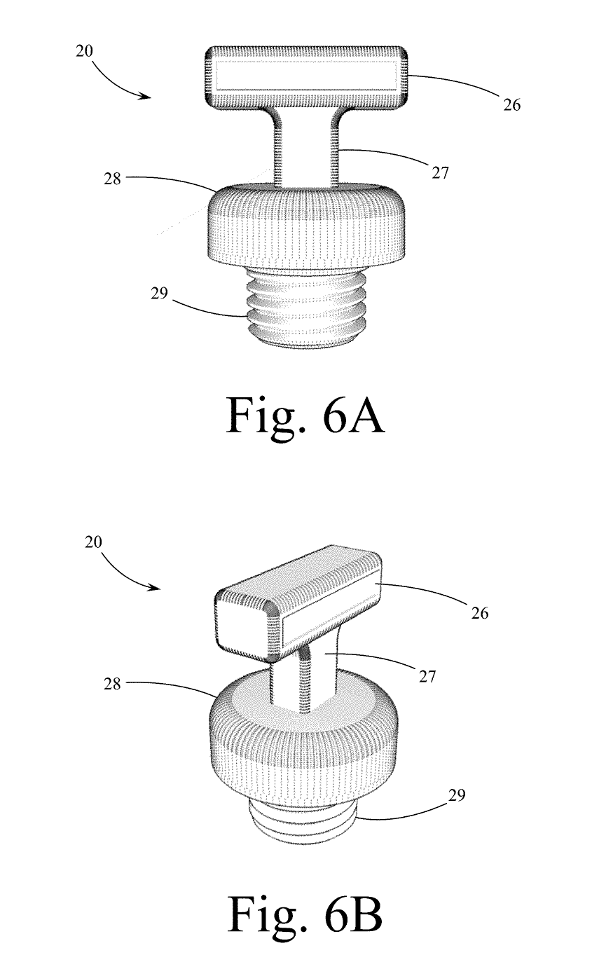

The final component associated with the bottle carousel system shown generally in FIG. 1 and again in FIG. 2 is shown in FIGS. 6A & 6B. Tower top 20 is a simple component designed first to secure the topmost carrousel clip within the system and secondly to provide a handle at the top of the overall structure by which the user may move the carousel tower from one location to another. Tower top 20 is constructed of top handle grip 26 positioned on top handle post 27 which extends from top trunk cap 28. Below top trunk cap 28 is threaded cap post 29 which, as described above, is sized and structured to be threaded into trunk threaded connector cup 44 shown in FIG. 4A. Here again the size and structure of threaded cap post 29 is such that tightening the threaded structure into the trunk threaded connector cup of the topmost trunk cylindrical body secures the topmost carousel clip wheel in position without preventing it from rotating between the engaging surfaces. Again as shown in FIG. 6B from a perspective view, tower top 20 may preferably be constructed from a unitary piece of material such as a polymer plastic, although other materials may be utilized as this topmost structure does not require the resiliency associated with the individual bottle clip construction material.

While the above described bottle carousel system has been shown constructed and assembled from a number of modular components, other manufacturing methods are appropriate for providing the same multi-level, multi-clip structure. Bottle carousel systems, specifically manufactured to have one, two, or three levels, may be manufactured using a simpler split mold construction method. The important structural features of the bottle carousel system shown and described above generally in FIGS. 1 & 2 relate to the tiered and organized arrangement that the structure provides rather than the particular method of manufacturing the center column, the base, or even the individual clip wheels.

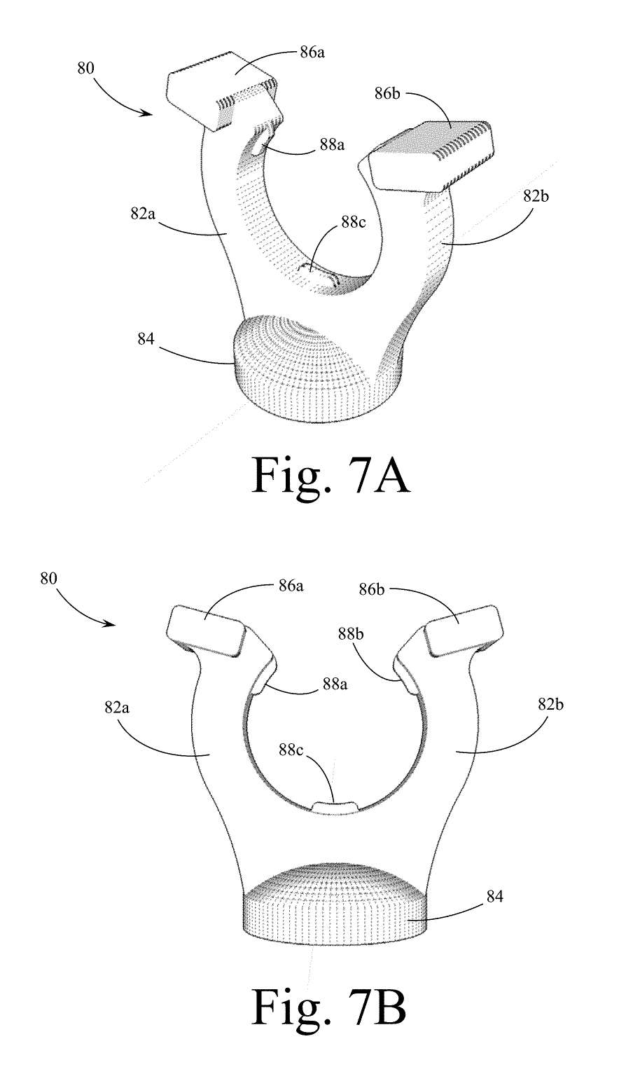

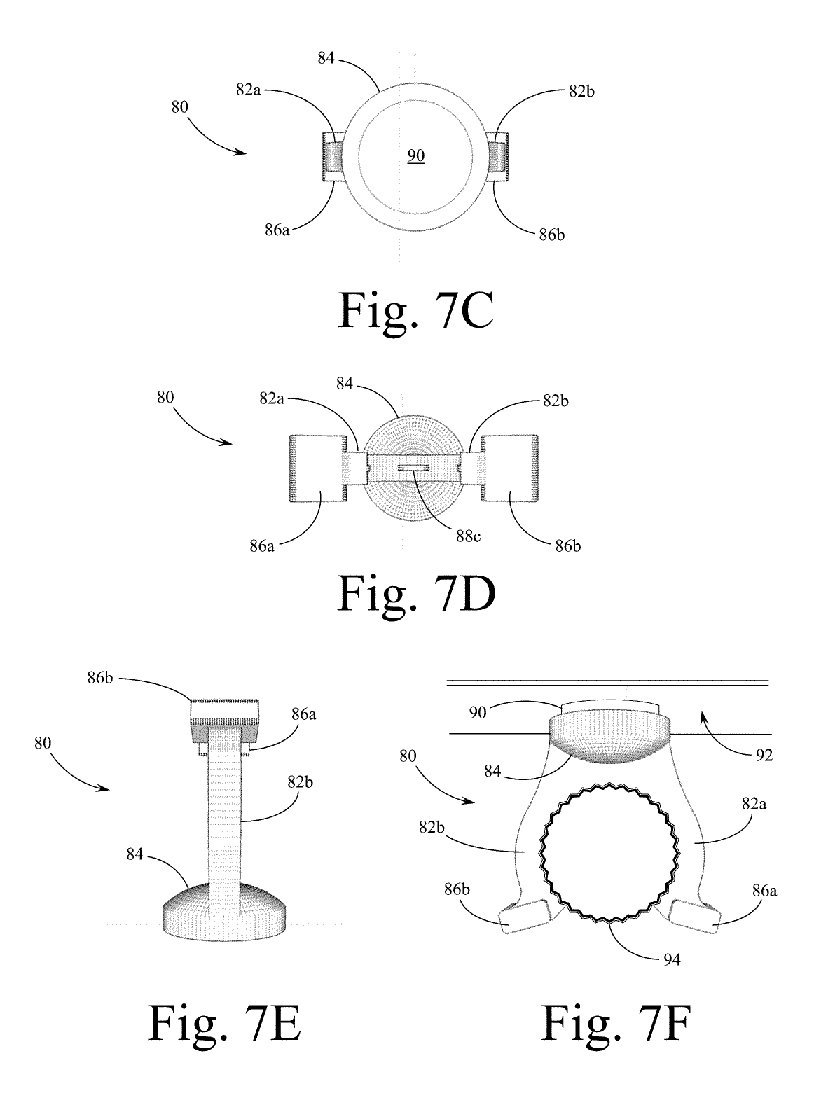

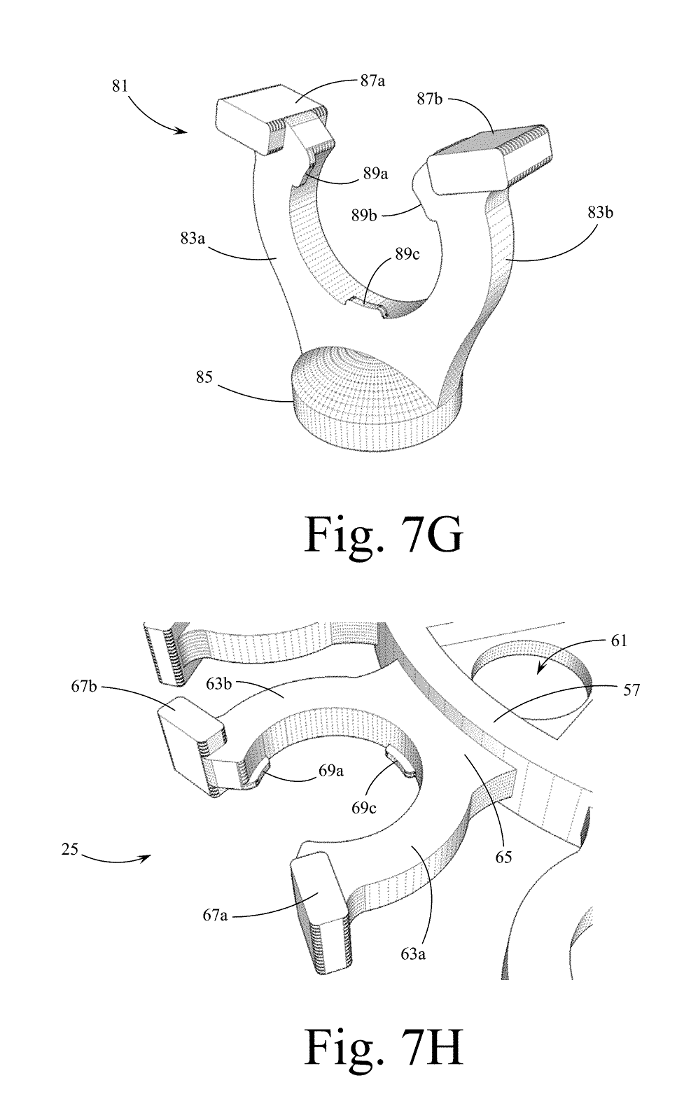

While the first preferred embodiment of the present invention is the bottle carousel system shown and described generally in FIGS. 1 & 2, and in more detail in the figures thereafter, alternate embodiments of some components of this system are anticipated. A second preferred embodiment of the present invention involves the removal of an individual bottle clip structure from the carousel clip wheel structure of the first preferred embodiment. The individual bottle clip 80 shown in FIGS. 7A-7F allows an individual user to provide a bottle clip that is disassociated with a specific carousel tower or other positioning mechanism. The embodiment shown in FIGS. 7A-7F is a clip structured with a strong magnet (or other reusable adhesive surface) on its base that allows the user to position the clip, and therefore the bottle, onto any of a number of different ferromagnetic (or other adhesive) surfaces.

Organizing and display surfaces that are made up of ferromagnetic materials or ferrous metals are quite common and may be easily constructed from simple components as described below. In fact, many surfaces in a typical household provide vertical, or nearly vertical, flat metallic surfaces onto which the combination of a bottle clip and bottle, according to the present invention, might be displayed and organized. Some metal surfaces are, of course, not ferromagnetic and would therefore not lend themselves to use in connection with this second preferred embodiment. Many such household surfaces however are ferromagnetic such as appliances in the kitchen and other types of small and large cabinets and containers. In addition, again as described below, various simple yet useful ferromagnetic surfaces may be constructed and positioned on non-ferromagnetic surfaces to facilitate the same functionality associated with the individual bottle clip containing a strong magnetic base. Once again, it is the improvement in the strength of small magnets using improved magnetic materials that allows for an individual bottle clip to be capable of positioning and retaining a bottle of corresponding size and shape. The primary difference in the use of the bottle clips in this second preferred embodiment and the bottle clips in the first preferred embodiment is the manner in which the user positions the bottle within the clip and/or removes the bottle from the clip. In the above first preferred embodiment the clip is held in place by the carousel or other structure to which it is secured or from which it is formed. In the second preferred embodiment the individual user would typically handle the bottle clip with one hand and the bottle with the other hand and insert or remove the bottle from the clip enclosure accordingly.

Although the present invention provides a most effective application when used in connection with strong magnetic components, other types of reusable adhesive materials and surfaces may be substituted in place of the magnetic and ferromagnetic components. Micro-suction and nano-suction materials have been recently developed that provide surfaces that adhere to each other with a force sufficient to hold relatively significant weights. For objects such as the bottle containers described in the present invention, nano-suction surfaces can provide the necessary retention force required to hold a full essential oil bottle or the like. A key feature of an appropriate reusable adhesive surface is that the adhesion be strong enough to hold the weight of the container held within the clip and yet weak enough that the user can easily remove and reposition the clip to a new location. This requirement makes the use of hook and loop type attachment surfaces less desirable, albeit still potentially useful, for the weight and force associated with the bottle containers of the present invention. Nonetheless, a wide range of reusable adhesive structures are anticipated with magnetic components being the preferred structures, nano-suction surfaces being appropriate structures, and hook and loop surfaces being potentially useful, but less desirable.

FIG. 7A is a perspective view of an individual bottle clip 80 shown constructed with clip arms 82a & 82b. These clip arms extend up from clip base 84 and generally are configured in a manner similar to the clip structures described above. The clip arms terminate with optional clip arm handles 86a & 86b respectively. The internal wall of the C-shaped clip is structured with base retention tab 88c and arm clip retention tabs 88a & 88b (shown most clearly in FIG. 7B). In the embodiments shown in FIG. 7A retention tabs 88a-88c are centrally positioned within or on the curved interior wall defined by clip arms 82a & 82b. As shown in the elevational view of FIG. 7B the outwardly functional structures of individual bottle clip 80 are generally the same or similar to the structures of the individual bottle clip shown as an extension of the carousel clip wheel in FIG. 5C.

The primary distinction in the second preferred embodiment is in the construction of clip base 84. FIG. 7C provides a bottom view of individual bottle clip 80 showing clip base 84 with base magnet 90 centrally positioned and permanently adhered therein. Extending up from clip base 84 are clip arms 82a & 82b which terminate in clip arm handles 86a & 86b.

FIG. 7D is a top view of the same individual bottle clip 80 which shows clip base 84 from the top with clip arms 82a & 82b extending upward therefrom. Optional clip arm handles 86a & 86b are shown as forming the ends of clip arms 82a & 82b with the opening of the clip positioned there between. Clip arm handles 86a & 86b do provide a wider surface area by which the user might grasp clip arms 82a & 82b to facilitate both the removal of the bottle or its insertion into the clip. These wider structures, however, are not essential to the effective operational use of the clip as clip arms 82a & 82b could extend to terminal ends having a width the same as or similar to the width of the entire arm structures. With such an embodiment, clip arm handles 86a & 86b as shown in FIG. 7D would simply represent the ends of clip arms 82a & 82b and generally be constructed of the same material with the same thickness. Base clip retention tab 88c is shown in its central position in the middle of the clip opposite the clip opening. FIG. 7E is a side view of individual bottle clip 80 showing clip base 84, clip arm 82b with clip arm handle 86b at the top. Clip arm handle 86a is partially in view in FIG. 7E.

Bottle clip 80 is of course designed to be positioned on a ferromagnetic adhesion surface 92 as shown in FIG. 7F. Base magnet 90 is secured within clip base 84 (typically with a permanent adhesive) and extends therefrom so as to engage ferromagnetic surface 92. In the top view shown in FIG. 7F, bottle cap 94 of a bottle (not shown in its entirety in FIG. 7F) is positioned over and between clip arms 82a & 82b with the neck band portion of the bottle (not shown) actually being gripped by clip arms 82a & 82b. Once again clip arm handles 86a & 86b may be used to facilitate the insertion and removal of the bottle into bottle clip 80. The combination bottle clip 80 and bottle may be moved to any position on the ferromagnetic adhesion surface 92 by the user and may be rotated into vertical or horizontal orientations on the surface.

Reference is next made to FIGS. 7G & 7H for detailed descriptions of an alternate structure for the individual bottle clips disclosed in the above first and second preferred embodiments. FIG. 7G provides the alternate structure implemented on the separate individual bottle clip 81 with clip base 85 incorporating a permanent magnet (not shown). In this alternate structure, clip arms 83a & 83b again extend upward from clip base 85 and terminate with clip arm handles 87a & 87b. In this case however base clip retention tab 89c and arm clip retention tabs 89a & 89b have been moved from a center line on the internal cylindrical wall of the clip to one edge of the wall of the clip structure. This modification in the position of the tabs helps each of the tabs fit under the bottle neck band before the security seal is broken on new bottles. Placing the tabs in the middle of the inside face of the clip is optimal for use with bottles where the security seal has been broken and a gap has been formed between the bottle neck band and the bottle cap. The embodiment shown in FIGS. 7G & 7H may be preferable given that both opened and unopened bottles may be utilized. FIG. 7H shows the same retention tab placement in connection with a clip structured according to the first preferred embodiment of the present invention described above. In FIG. 7H, individual body clip 25 is shown attached to (formed with) perimeter clip rim 57. Clip base 65 extends out from perimeter clip rim 57 opposite finger grip aperture 61. Clip arms 63a & 63b extend from clip base 65 and terminate in clip arm handles 67a & 67b. Base clip retention tab 69c is shown positioned adjacent clip base 65 flush with the bottom edge of the clip (in this view). In a similar manner, arm clip retention tab 69a is positioned near the clip opening on clip arm 63b again flush with the bottom edge of the interior clip wall.

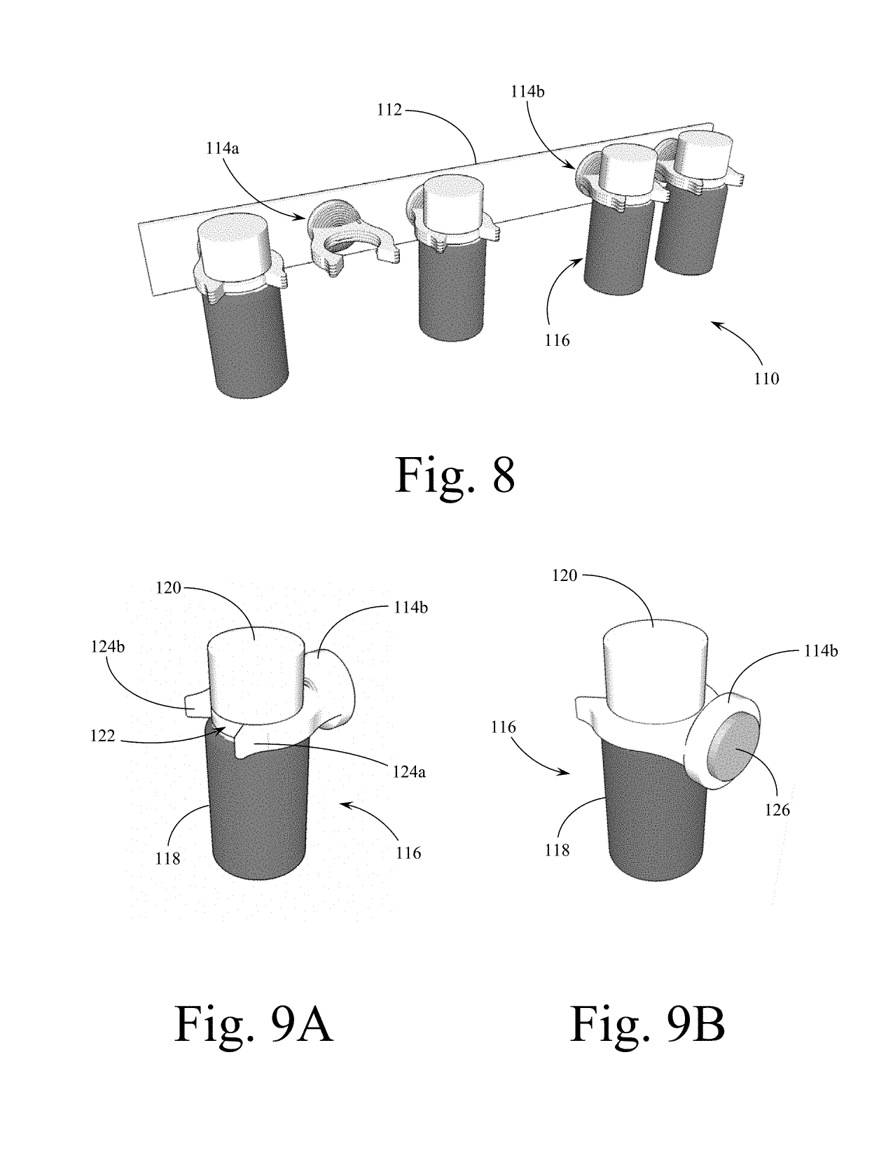

Reference is next made to FIG. 8 and FIGS. 9A-9B. FIG. 8 shows a number of docking bottle clips 114a & 114b (for example) positioned on a docking bar 112. The bottle docking bar system 110 shown in FIG. 8, initially suggested above, provides a simple section of ferromagnetic (or other reusable adhesive) material making up docking bar 112 that may be positioned (permanently or removably) on any vertical surface and used to secure and arrange docking bottle clips with and without essential oil bottles. Docking bottle clip 114a is shown positioned on docking bar 112 empty of an essential oil bottle while docking clip 114b retains essential oil bottle 116. While docking bar 112 in FIG. 8 is shown to be essentially one clip tall and any number of clips wide, many variations in the size and shape of the docking bar are anticipated. A large docking panel (not shown) could create an arrangement array of bottles and clips in an organized or unorganized pattern.

FIGS. 9A & 9B provide greater detail on the structures of the clips and the manner of attachment to the bottles that might be utilized in the bottle docking bar system 110 shown in FIG. 8. In these views, essential oil bottle 116 is made up of bottle container 118, bottle cap 120, and bottle neck band 122. FIG. 9A is a front perspective view of docking bottle clip 114b showing clip arms 124a & 124b which engage bottle neck band 122 of essential oil bottle 116. When bottle 116 is positioned within docking bottle clip 114b, bottle cap 120 is positioned above the clip and bottle container 118 is positioned below the clip.

FIG. 9B is a rear perspective view of the same docking bottle clip 114b holding essential oil bottle 116 with bottle cap 120 and bottle container 118 shown extending above and below the clip respectively. Base magnet 126 is shown where it is permanently adhered to the bottom of the base of docking bottle clip 114b. Once again, alternate reusable adhesive surfaces may be used in place of base magnet 126 and docking bar 112 (in FIG. 8).

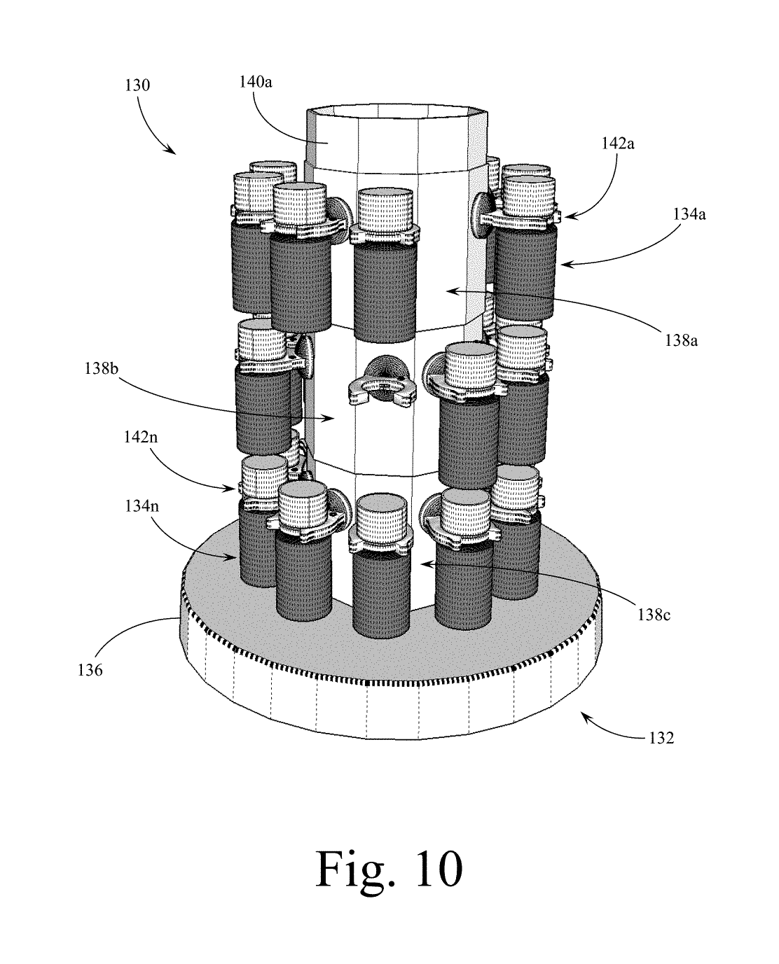

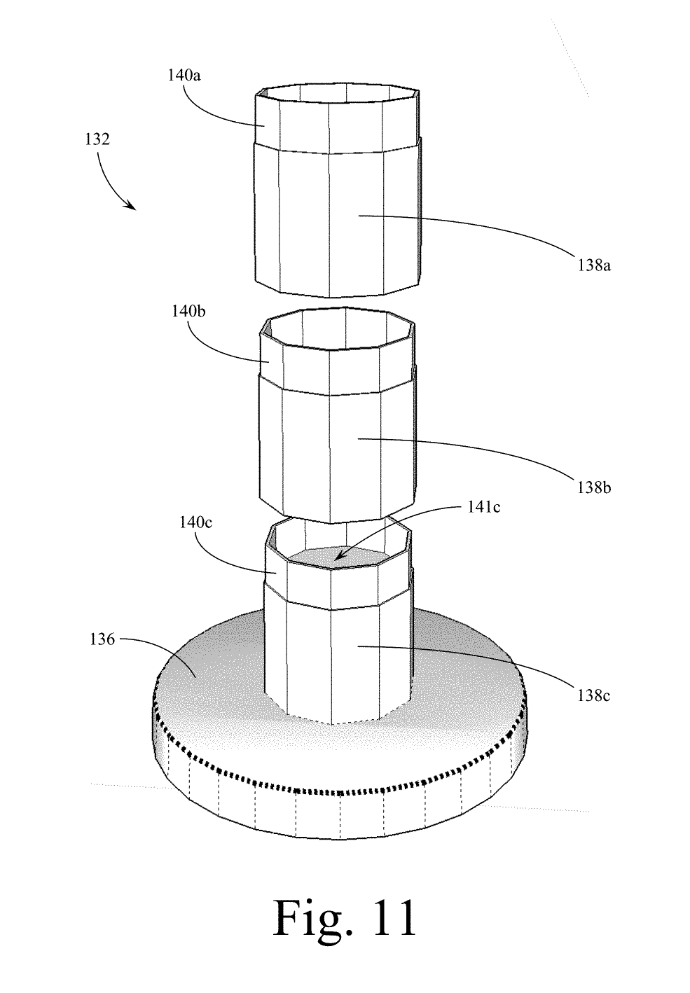

A further preferred embodiment of the system of the present invention is disclosed in FIGS. 10 & 11 wherein a hybrid of the first and second embodiments is utilized. Magnetic bottle docking system 130 provides for a carousel tower similar to the first preferred embodiment described above, but utilizing the second preferred embodiment of the bottle clip structures. Magnetic bottle docking system 130 is made up of magnetic docking tower 132 which is structured with magnetic docking tower base 136 and tower trunk modules 138a-138c. The manner in which these components connect together is shown and described with FIG. 11 below. As with the first described embodiment of the carousel tower, various ways of manufacturing and assembling the tower components are anticipated.

Individual magnetic base bottle clips 142a-142n are positioned on the flat ferromagnetic surfaces of each of tower trunk modules 138a-138c. Each panel constructed on the polygonal trunk modules is sized to receive and support one magnetic base bottle clip. These clips may be positioned without bottles (as shown on tower trunk module 138b) or with bottles as shown with the balance of the clips in FIG. 10. As indicated above, it is anticipated that the user will secure a bottle into a clip and then position the combination on one of the empty flat ferromagnetic surface panels on the tower.

FIG. 11 shows the same magnetic docking tower 132 with each of the bottles removed and the tower trunk modules separated to show the manner of assembly. Magnetic docking tower 132, once again, is constructed from magnetic docking tower base 136 onto which is positioned tower trunk module 138c. Module interlock top 140c forms module top container 141c on tower trunk module 138c. Tower trunk module 138b has an incrementally larger base (interior not shown) that receives and interlocks with module interlock top 140c. Likewise tower trunk module 138a interlocks with tower trunk module 138b by means of module interlock top 140b. Module interlock top 140a on tower trunk module 138a remains open (unless additional levels to the tower are desired) and forms a container cup for the temporary loose placement of bottles or clips.

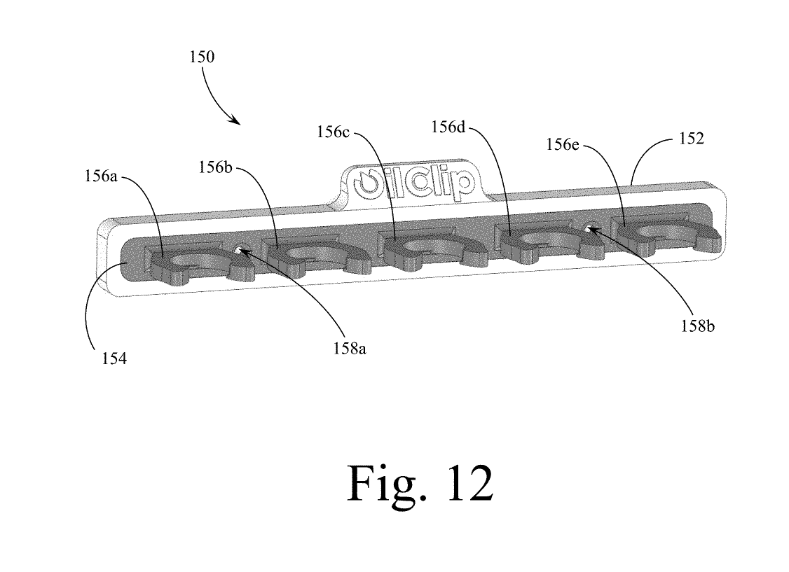

Reference is finally made to FIG. 12 for a description of an alternate embodiment of the docking strip shown in FIG. 8. Docking strip 150 in FIG. 12 provides a linear row of fixed bottle clips 156a-156e integrally formed in a strip 154 made up of the preferred thermoplastic polyurethane (TPU) material. Strip 154 is fixed within a strip base 152 which is preferably made from a more rigid material such as ABS plastic. Mounting holes 158a & 158b are positioned through both materials as shown, and provide one manner of securing docking strip 154 to a vertical surface with screws or the like (not shown). Alternately, an adhesive mounting surface may be placed on the rear face of strip base 152 to secure the docking strip to a vertical surface (such as a wall, a mirror, a cabinet door, a drawer side, or other relatively smooth fixed vertical surface).

Although the present invention has been described in connection with certain preferred embodiments, those skilled in the art will recognize that the basic elements of the invention extend across each of the embodiments described. Variations as to dimensions and even geometry for the components that result from variations in the bottle container sizes to be utilized with the docking systems are anticipated. Although the present invention lends itself most usefully to small bottles such as essential oil bottles, larger and smaller bottles may be utilized in connection with systems adapted by scaling up or scaling down the component dimensions. The only component of the present invention where the construction material is significant is the individual bottle clip component. As indicated above, it is preferable that the material the clip is constructed from be sufficiently rigid and resilient as to allow for a spreading of the clip opening for insertion of the bottle therein. A preferred class of materials is thermoplastic polyurethane (TPU). Other elements used in the construction of the bottle docking system of the present invention (apart from the required magnetic or ferromagnetic components and/or other reusable adhesive surfaces) are not so limited in their construction. A wide variety of different materials may be suitable for the various structures although polymer plastic materials that are moldable into the forms shown are preferable.

As indicated above, the magnetic versions of the present invention are facilitated by the use of certain permanent rare earth magnets preferably made from neodymium. Such high strength magnets (neodymium magnets are the strongest type of permanent magnet commercially available) are now relatively inexpensive. The size of the magnets shown in the present disclosure (diameters in the same range as the diameter of the cylindrical bottle) are more than sufficient to position and retain a bottle clip with a full essential oil bottle positioned therein. Although other types of magnets may be used, the appropriate size of the magnet may be too large for the size of the bottle when a weaker type of permanent magnet is utilized.

While the use of high strength magnets is described as the preferred embodiment of the present invention, other mechanisms for removably attaching bottle clips to vertical surfaces are anticipated. While none might function as efficiently and effectively as the magnetic clip versions, embodiments involving other types of reusable and repositionable adhesive surfaces are anticipated. In addition, suction cup or hook and loop surface attachment systems may, under some circumstances be utilized in place of the magnet/ferromagnetic surface combination that is the preferred embodiment.

We claim:

1. A clip for removably holding and displaying a generally cylindrical bottle, the bottle having a neck and a cap, the clip comprising:
a clip base, the clip base comprising a front face and a back face;
a pair of clip arms, each clip arm extending in a semi-circular arc from the front face of the clip base; and
an adherent surface member positioned in association with the back face of the clip base;
wherein the clip arms partially define a circular space into which the generally cylindrical bottle may be inserted and retained.

2. The clip of claim 1 wherein the adherent surface member comprises a neodymium magnet.

3. The clip of claim 1 wherein the clip arms extend to define a semi-circle with an arc in the range of 250 to 310 degrees.

4. The clip of claim 1 wherein each clip arm extends away from the clip base and terminates in a clip arm handle, each clip arm handle comprising an extension oriented outward from the semi-circular arc of the clip arm and providing finger grip points for a user to engage the clip.

5. The clip of claim 1 further comprising a plurality of retention tabs positioned on an inside semi-circular surface defined by the clip arms and the clip base, the retention tabs oriented into the circular space partially defined by the clip arms and positioned to be received into a gap at the neck of the bottle below the cap of the bottle.

6. The clip of claim 5 wherein the plurality of retention tabs comprise a first retention tab centered between the clip arms on the clip base, a second retention tab positioned at a terminal end of a first of the pair of clip arms, and a third retention tab positioned at a terminal end of a second of the pair of clip arms.

7. The clip of claim 1 wherein the clip arms comprise a resilient polymer plastic material.

8. The clip of claim 7 wherein the resilient polymer plastic material comprises a thermoplastic polyurethane material.

9. The clip of claim 1 wherein the clip base and the pair of clip arms are formed from a unitary polymer plastic material and the back face of the clip base defines a recess into which the adherent surface member is fixed.

10. The clip of claim 1 wherein the adherent surface member comprises a surface layer of nano-suction material.

11. A stand for removably holding and displaying a plurality of generally cylindrical bottles, each of the plurality of generally cylindrical bottles having a neck and a cap, the stand comprising:
a stand base, the stand base having a top and a bottom, the stand base bottom configured to be placed on and supported by a generally horizontal surface;
a stand trunk, the stand trunk extending vertically from the top of the stand base; and
at least one clip wheel positioned concentrically on and supported by the stand trunk, the at least one clip wheel comprising:
a central support member connecting the clip wheel to the stand trunk; and
a radial array of bottle clips, each bottle clip in the radial array comprising:
a clip base, the clip base comprising a radial support member connecting the bottle clip to the central support member; and
a pair of clip arms, each clip arm extending in a semi-circular arc from the clip base;
wherein the clip arms of each bottle clip defines a circular space into which one of the generally cylindrical bottles may be inserted and retained.

12. The stand of claim 11 wherein the at least one clip wheel comprises a plurality of clip wheels and the stand trunk comprises a plurality of trunk sections, one associated with and retaining each of the plurality of clip wheels.

13. The stand of claim 11 wherein the at least one clip wheel is movably supported on the stand trunk whereby a user may rotate the clip wheel on the clip stand to move different bottles positioned on the clip wheel into view.

14. The stand of claim 12 wherein the plurality of clip wheels are movably supported on the stand trunk whereby a user may independently rotate each of the clip wheels on the clip stand to move different bottles positioned on the clip wheel into view.

15. The stand of claim 11 wherein the radial array of bottle clips on each of the at least one clip wheel comprises ten bottle clips.

16. The stand of claim 11 wherein each clip arm extends away from the associated clip base and terminates in a clip arm handle, each clip arm handle comprising an extension oriented outward from the semi-circular arc of the clip arm and providing finger grip points for a user to engage the clip, wherein the user may use their fingers to grip a clip arm handle of one clip and a clip arm handle of an adjacent clip to partially open a clip to remove a bottle held therein.

17. The stand of claim 11 wherein the central support member of the at least one clip wheel comprises a support ring concentrically supported on the stand trunk, the radial support members of the radial array of bottle clips collectively comprise a circular framework extending from the support ring to the radial array of clip arm pairs.

18. A bracket assembly for removably holding and displaying a plurality of generally cylindrical bottles, each of the bottles having a neck and a cap, the bracket assembly comprising:
a generally rigid plate, the plate comprising a front face and a back face, the back face of the plate mountable to a generally vertical surface, the front face of the plate comprising an adherent surface;
a plurality of bottle clips, each bottle clip comprising:
a clip base, the clip base comprising a front face and a back face;
a pair of clip arms, each clip arm extending in a semi-circular arc from the front face of the clip base; and
an adherent surface member positioned on the back face of the clip base, the adherent surface member generally adherent to the adherent surface of the front face of the plate;
wherein the clip arms of each of the plurality of bottle clips define a circular space into which one of the plurality of generally cylindrical bottles may be inserted and retained, and wherein each of the plurality of bottle clips may be removably positioned on the front face of the plate.

19. The bracket assembly of claim 18 wherein the adherent surface member comprises a magnet and the front face of the plate comprises a ferromagnetic material.

20. The bracket assembly of claim 19 wherein the clip base of each of the plurality of bottle clips has a height dimension and the generally rigid plate comprises a longitudinal, generally rectangular, metal plate having a height dimension approximately the same as the height dimension of a clip base.
